(19) United States
(12) Patent Application Publication
(10) Pub. No.: US 2013/0038255 A1
(43) Pub. Date: Feb. 14, 2013

(54) Energy Recapturing Apparatus

(71) Applicant: Adam G. Trainque, New Orleans, LA (US)

(72) Inventor: Adam G. Trainque, New Orleans, LA (US)

(21) Appl. No.: 13/206,698

(22) Filed: Aug. 10, 2011

(51) Int. Cl. H02P 3/14

(52) U.S. Cl. 318/376

(57) ABSTRACT

An energy recapturing apparatus is disclosed for use with a ceiling fan that includes a housing defining an interior area and having a rotatable fan blade assembly. The apparatus includes a combined motor/generator situated in the housing interior space, the motor/generator being operatively connected to the fan blade assembly to apply energy to rotate the fan blade assembly when energized and to receive kinetic energy from rotation of the fan blade assembly when de-energized. A switch is electrically connected to the motor/generator to selectively energize or de-energize the motor/generator. The motor/generator is configured to generate electricity from the kinetic energy received from the fan blade assembly. An electricity storage device is electrically connected to the motor/generator and configured to store electricity generated by the motor/generator. A controller causes stored electricity to be transferred to the motor/generator upon its activation.

### BACKGROUND OF THE INVENTION

This invention relates generally to energy saving devices and, more particularly, to an apparatus for use with a ceiling fan that recaptures energy by converting the kinetic energy of deactivated fan blades into electricity and storing it for use upon the next fan activation.

Energy savings has become an important political issue as energy resources globally have become scarce or expensive in some cases. Environmental concerns have led to major initiatives to “go green” in an effort to preserve the environment from the negative effects of energy usage. At the consumer level, many people have a desire to save energy to show their own personal environmental commitment and also to save money. Specifically, residential homeowners are attempting to save on the cost of electricity usage by shutting off lights when not in use, using high efficiency light bulbs, or keeping their homes a little cooler in the winter and a little warmer in the summer.

Therefore, it would be desirable if even small amounts of electricity used within a home environment could be recaptured for subsequent usage, such as recapturing electricity from a ceiling fan when the fan assembly is deactivated to be used the next time the fan is energized. Specifically, it would be desirable to have an electricity recapturing apparatus that converts the kinetic energy of a fan assembly as it winds down after being de-energized into electricity. The generated electricity may be stored in an electricity storage device such as a capacitor and used the next time the ceiling fan is energized.

### SUMMARY OF THE INVENTION

The present invention includes an energy recapturing apparatus for use with a ceiling fan that includes a housing defining an interior area and having a rotatable fan blade assembly. The apparatus includes a combined motor/generator situated in the housing interior space, the motor/generator being operatively connected to the fan blade assembly to apply energy to rotate the fan blade assembly when energized and to receive kinetic energy from rotation of the fan blade assembly when de-energized. A switch is electrically connected to the motor/generator to selectively energize or de-energize the motor/generator. The motor/generator is configured to generate electricity from the kinetic energy received from the fan blade assembly. An electricity storage device is electrically connected to the motor/generator and configured to store electricity generated by the motor/generator. A controller causes stored electricity to be transferred to the motor/generator upon its activation.

Therefore, a general object of this invention is to provide an energy recapturing apparatus for converting kinetic energy from ceiling fan blades as they rotate after being de-energized into electricity.

Another object of this invention is to provide an energy recapturing apparatus, as aforesaid, for storing generated electricity until a ceiling fan is again energized.

Still another object of this invention is to provide an energy recapturing apparatus, as aforesaid, that saves energy by capturing and utilizing energy from operation of a ceiling fan that would otherwise be lost.

Yet another object of this invention is to provide an energy recapturing apparatus, as aforesaid, that is easy to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an energy recapturing apparatus in use with a ceiling fan according to a preferred embodiment of the present invention;

FIG. 2 is a side view of the apparatus and ceiling fan as in FIG. 1;

FIG. 3a is a bottom view of the apparatus and ceiling fan as in FIG. 2;

FIG. 3b is a sectional view taken along line 3b-3b of FIG. 3a; and

FIG. 4 is a block diagram illustrating the electric components of the present invention.

### DESCRIPTION OF THE PREFERRED EMBODIMENT

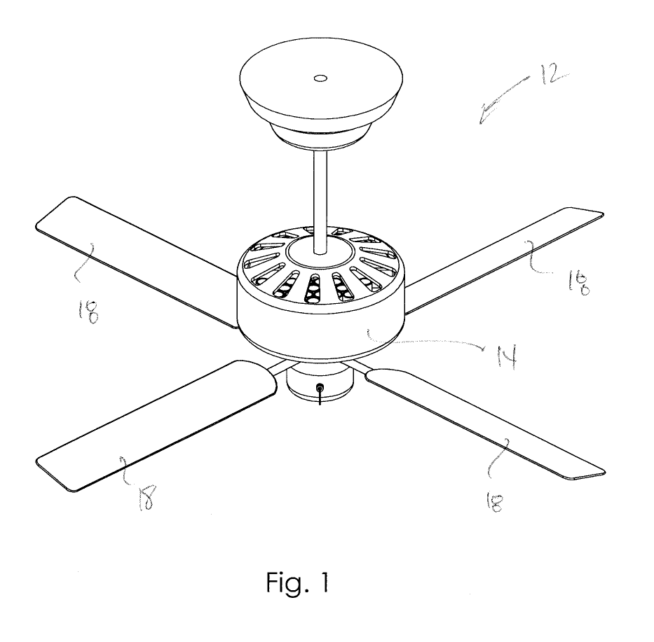

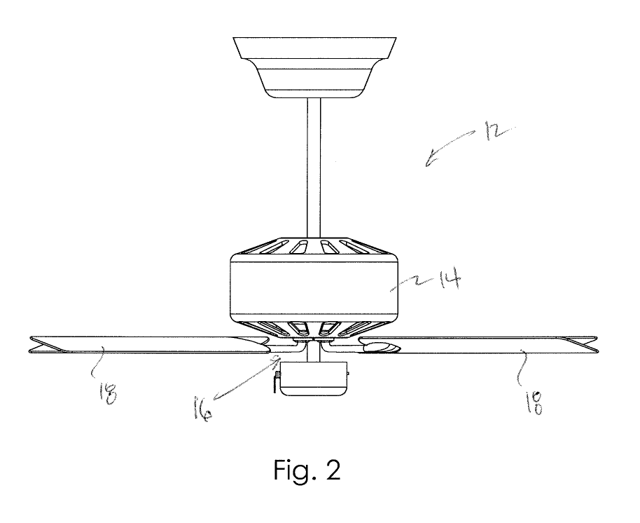

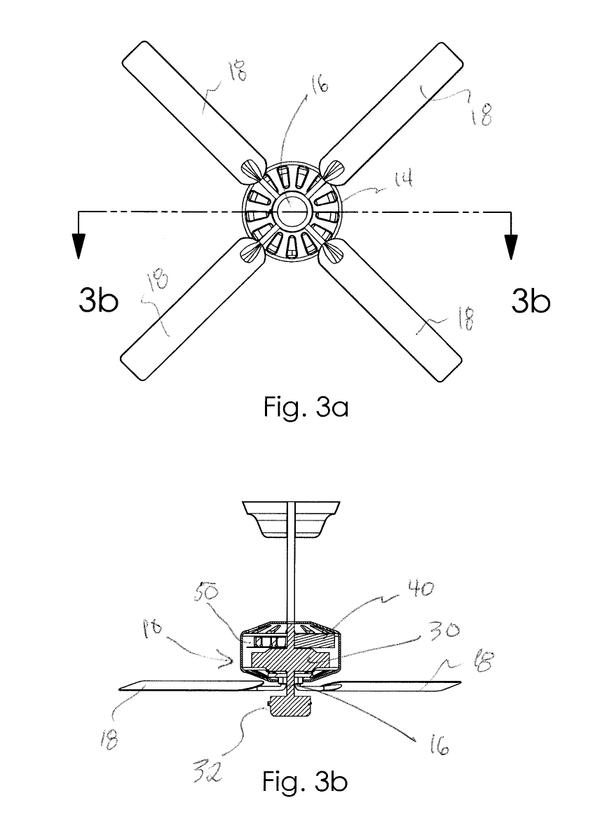

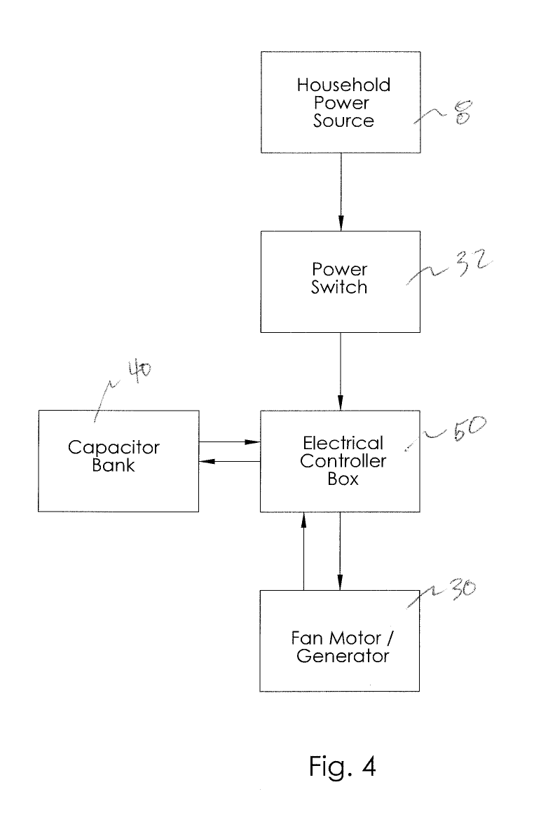

An energy recapturing apparatus according to the present invention will now be described with reference to FIGS. 1 to 3 of the accompanying drawings. The energy recapturing apparatus 10 includes a motor/generator 30, electricity storage device 40, and a control circuit 50.

The energy recapturing apparatus 10 may be incorporated as a component of a ceiling fan 12 at the point of manufacture or included as an aftermarket product. In either case, the apparatus 10 is intended for use with a conventional ceiling fan 12 of the type that includes a housing 14 having top, bottom, and side walls that define an open interior area 20. The preferred type of ceiling fan 12 also includes a fan blade assembly 16 having a plurality of blades 18 that are operable to rotate around a central hub, the blades 18 extending outwardly from the housing 14.

The motor/generator 30 may be positioned in the interior area 20 of the housing 14 of the ceiling fan 12. Preferably, the motor/generator 30 is a unitary device. The device operates as a conventional motor if power is being supplied to the device and as a generator if it is supplying electricity. The motor/generator 30 is operatively connected to the fan blade assembly 16 of the ceiling fan 12. It is understood that this connection may be made at the time of manufacture or easily retrofitted later, such as if the motor/generator and other parts of this invention are sold as an aftermarket product.

The motor/generator 30 is operably connected to the fan blade assembly 16 such that the fan blade assembly 16 is actuated to rotate when the motor/generator 30 is energized. The motor/generator 30 may be electrically connected to a power source such as the A/C power supply 8 of a residential or commercial electrical outlet. A switch 32 is situated on or adjacent to the ceiling fan 12 that is electrically connected to the motor/generator 30 for selectively emerging or de-energizing the motor/generator 30. In other words, a user may turn the fan on or off in a traditional manner.

The motor/generator 30 being connected to the fan blade assembly 16 also enables the generator to receive energy from the fan blade assembly 16. Specifically, the fan blades of the fan blade assembly 16 produce kinetic energy as they spin. This kinetic energy may be collected as the fan blade assembly 16 winds down when the motor/generator 30 is de-energized (i.e. switched off). When the motor/generator 30 receives the kinetic energy, say, in the form of turning a shaft, the motor/generator 30 produces electricity.

The energy recapturing apparatus 10 further includes an electricity storage device 40 positioned in the housing interior area 20 and configured to receive and store electricity generated by the motor/generator 30. More particularly, the electricity storage device 40 may be electrically connected to the motor/generator 30 such that electricity generated by the motor/generator 30 is transferred to the electricity storage device 40 immediately as it is generated. The electricity storage device 40 may be one or several capacitors which are well known as storage media for electric current. Alternatively, the electricity storage device 40 may be one or more rechargeable batteries.

The energy recapturing apparatus 10 may also include a control circuit 50 (also referred to as a controller) that is configured to regulate the transfer of electricity to and from the motor/generator 30. More particularly, the control circuit 50 may actuate the motor/generator 30 to begin converting kinetic energy from the wind-down of the fan blade assembly 16 immediately when the fan blade assembly 16 is de-energized by operation of the switch 32. The control circuit 50 may also be configured to regulate transfer of generated electricity to the one or more electricity storage devices.

Importantly, the control circuit 50 is also configured to transfer electricity stored in the electricity storage device 40 to the motor/generator 30 immediately when the motor/generator 30 is energized by operation of the switch 32. In other words, when a user turns on the ceiling fan 12 using the on/off switch 32, electricity is first obtained from the storage device 40 prior to the motor/generator 30 drawing any electricity from any other source, such as from an A/C power outlet. In this way, energy for the initial windup of the fan blade assembly 16 may be drawn from the electricity generated and stored from a previous wind down.

In use, the energy recapturing apparatus 10 may be incorporated into a ceiling fan 12 at the point of original manufacture or retrofitted into an existing ceiling fan 12. Upon operation of the switch 32, the motor/generator 30 actuates the fan blade assembly 16 to rotate. Then, when the switch 32 is turned off, the fan blade assembly 16 is de-energized. As the fan blades 18 continue to rotate for a brief time pursuant to their own kinetic energy, the kinetic energy is received by the motor/generator 30 and converted into electricity. The electricity is then stored in the electricity storage device 40, where it will remain until the fan blade assembly 16 is re-energized by operation of the switch 32. When re-energized, current stored in the electricity storage device 40 is transferred to the motor/generator 30 prior to any current from another power source 8 is used.

It is understood that while a unitary motor/generator 30 be utilized with the present invention, an independent motor and generator would also work. The motor would supply power to the fan blade assembly 16 and the generator would receive the kinetic energy from the fan blade assembly 16 and generate electricity as a result.

It is also understood that the controller may include a processor having programming instructions for controlling the transfer of electricity as described above and for actuating operations of the motor/generator 30 and fan blade assembly 16.

In another aspect of the present invention (not shown), the energy recapturing apparatus 10 may include a plurality of weights, such as pieces of metal, each weight being slidably coupled to a respective blade 18 of the ceiling fan 12. If included at the point of original manufacture, each weight may be positioned in an interior cavity defined by each respective blade 18. Each weight is naturally biased to be positioned at or adjacent to a proximal end of a respective blade (i.e. end nearest the blade assembly hub). When the fan blade assembly 16 is energized to rotate, respective weights move by centrifugal force toward respective blade distal ends. When the fan blade assembly is de-energized, the weights return to their normal biased configuration, causing the blades to rotate for a longer period of time and thus produce a greater quantity of kinetic energy to be converted to electricity. It is understood that each weight may be coupled to the distal end by an elastic cord, spring, or the like such that the weight is extended outwardly as centrifugal force is increased but which is normally returned to its retracted position when the centrifugal force is removed.

It is understood that while certain forms of this invention have been illustrated and described, it is not limited thereto except insofar as such limitations are included in the following claims and allowable functional equivalents thereof.

1. An energy recapturing apparatus for use with a ceiling fan that includes a housing defining an interior area and having a rotatable fan blade assembly, said energy recapturing apparatus comprising:
a combined motor/generator situated in said housing interior space, said motor/generator being operatively connected to said fan blade assembly to apply energy to rotate said fan blade assembly when energized and to receive kinetic energy from rotation of said fan blade assembly when de-energized;
a switch electrically connected to said motor/generator to selectively energize or de-energize said motor/generator;
wherein said motor/generator is configured to generate electricity from said kinetic energy received from said fan blade assembly; and
an electricity storage device electrically connected to said motor/generator configured to store electricity generated by said motor/generator.

2. The energy recapturing apparatus as in claim 1, further comprising a control circuit electrically connected to said switch, said motor/generator, and said electricity storage device, said control circuit being configured to actuate said motor/generator to convert said received kinetic energy to electricity immediately upon said switch de-energizing said motor/generator.

3. The energy recapturing apparatus as in claim 2, wherein said control circuit is configured to transfer electricity generated by said motor/generator to said electricity storage device.

4. The energy recapturing apparatus as in claim 3, wherein said control circuit is configured to transfer electricity stored in said electrical storage device to said motor/generator immediately when said switch is operated to energize said motor/generator.

5. The energy recapturing apparatus as in claim 4, wherein said motor/generator is electrically connected to an AC power source.

6. The energy recapturing apparatus as in claim 1, wherein said electricity storage device is a capacitor.

7. The energy recapturing apparatus as in claim 1, wherein said electricity storage device is a battery.

8. The energy recapturing apparatus as in claim 7, wherein said control circuitry is a processor having programming for operating said motor/generator and said electricity storage device.

9. The energy recapturing apparatus as in claim 3, wherein said control circuit is configured to transfer electricity stored in said electrical storage device to said motor/generator when said switch is operated to energize said motor/generator prior to said motor/generator receiving electricity from any other power source.

10. An energy recapturing apparatus for use with a ceiling fan that includes a housing defining an interior area and having a rotatable fan blade assembly, said energy recapturing apparatus comprising:
a motor and an electric generator situated in the interior area, said generator being operatively connected to said motor;
wherein said motor is operatively connected to said fan blade assembly r to apply so as to apply energy to rotate said fan blade assembly when said motor is energized;
wherein said generator is operatively connected to said fan blade assembly for receiving kinetic energy from said fan blade assembly when said motor is de-energized;
a switch electrically connected to said motor and said generator for selectively energizing and de-energizing said motor to operate said fan blade assembly;
an electricity storage device situated in said interior area that is electrically connected to said electric generator and configured to store electricity generated by said generator; and
a controller electrically connected to said motor, said generator, and said electricity storage device, said controller having circuitry configured to actuate said generator to convert said received kinetic energy to electricity immediately upon said switch de-energizing said motor.

11. The energy recapturing apparatus as in claim 10, wherein said control circuit is configured to transfer electricity stored in said electricity storage device to said motor immediately when said switch is operated to energize said motor/generator.

12. The energy recapturing apparatus as in claim 11, wherein said control circuitry is a processor having programming for operating said motor/generator and said electricity storage device.

13. The energy recapturing apparatus as in claim 11, wherein said control circuit is configured to transfer electricity stored in said electricity storage device to said motor when said switch is operated to energize said motor prior to said motor receiving electricity from any other power source.

14. The energy recapturing apparatus as in claim 13, wherein said motor/generator is electrically connected to an AC power source.

15. The energy recapturing apparatus as in claim 10, wherein said electricity storage device is a capacitor.

16. The energy recapturing apparatus as in claim 10, wherein said electricity storage device is a battery.
